(19) United States
(12) Patent Application Publication
(10) Pub. No.: US 2016/0174594 A1
(43) Pub. Date: Jun. 23, 2016

(54) Display batch freezer for ice-creams, sorbets, slushes and similar products

(71) Applicants: Paolo Soffientini, San Fiorano (IT); Emanuela Cipelletti, San Fiorano (IT)

(72) Inventors: Paolo Soffientini, San Fiorano (IT); Emanuela Cipelletti, San Fiorano (IT)

(21) Appl. No.: 14/978,616

(22) Filed: Dec. 22, 2015

(30) Foreign Application Priority Data
Dec. 22, 2014 (IT) MI2014A002211

(51) Int. Cl. A23G 9/22

(52) U.S. Cl. CPC A23G 9/225

(57) ABSTRACT

A display batch freezer for ice-creams, sorbets, slushes and similar products, formed by a bench with a shelf in which a plurality of batch freezing receptacles having stirrers and being closed by respective lids is fitted, provides at each batch freezing receptacle a fixed support on which a tool is fitted removably for collecting the product; the tool has a gripping part and a collecting part; the tool is arranged with the gripping part outside the lid and with the collecting part inside the lid, and the lid has an opening for the tool to pass through the lid. Therefore, the hygiene is guaranteed during the product collection.

### FIELD OF THE INVENTION

It is an object of the present invention a display batch freezer for ice-creams, sorbets, slushes and similar products.

### BACKGROUND OF THE INVENTION

The batch freezer is a machine that allows transforming a liquid mixture in ice-cream by continuous stirring, the cold action and the air inclusion.

The batch freezer comprises one or more batch freezing receptacles being properly cooled, arranged horizontally or vertically, inside each of them a stirrer is rotating continuously.

There exist display batch freezers in the market, which have the function of producing and serving an ice-cream being processed in front of the client. This represents something different from the traditional refrigerating display having receptacles where different ice-cream types being prepared apart using separate batch freezers are presented.

Substantially, the display batch freezer comprises a bench having an upper shelf on which the batch freezing receptacles having stirrers are fitted. Inside the bench, the motors driving the stirrers and the refrigeration circuit are arranged, as well as all the several electrical and electronic components. Outside the bench, command panels are provided. The bench can be provided with awning, knick-knack shelves, protective glass, or other options, depending on the usage type and needs.

Each batch freezing receptacle is covered by a transparent lid that protects both the in progress and finished product and also allows the client to closely follow the ice-cream freezing process.

In the normal refrigerating displays having receptacles, in order to arrange the ice-cream on the cones or in the paper cups, usually a number of scoops, one for each receptacle, is used. When not used, each scoop is kept in the receptacle with the collecting part being inserted in the ice-cream.

In the display batch freezers, this cannot happen because in the batch freezing receptacle there is the stirrer and the ice-cream can be moving, therefore the scoop inside the batch freezing receptacle could cause damages.

To keep the scoop outside the batch freezing receptacle involves hygiene problems.

The hygiene problems are bound to the fact that, by keeping the scoop outside, the collecting part becomes a breeding-ground for bacteria, which can be transmitted to the ice-cream being collected using the scoop.

The hygiene situation gets worse if part of the collected ice-cream remains on the scoop and gets even worse if the bench and thus the scoop are in a hot ambient.

### SUMMARY OF THE INVENTION

Object of the invention is to propose a display batch freezer solving the above-mentioned hygiene problem.

That object is obtained by means of a display batch freezer according to the invention.

### BRIEF DESCRIPTION OF THE DRAWINGS

In order to better understand the invention, a description of one of its exemplary and non-limiting embodiment is reported in the following, being depicted in the attached drawings where:

FIG. 1 is a partial front perspective view of a display batch freezer according to the invention;

FIG. 2 is a front perspective view of a detail of the display batch freezer of FIG. 1;

FIG. 3 is a lateral perspective view of a detail of the display batch freezer of FIG. 1;

FIG. 4 is a front perspective view of an element of the display batch freezer of FIG. 1;

FIG. 5 is a front view of the element of FIG. 4;

FIG. 6 is a lateral view of the element of FIG. 4;

FIG. 7 is a lateral perspective view of a component being used in the display batch freezer FIG. 1;

FIG. 8 is a lateral view of the component of FIG. 7;

FIG. 9 is a top view of the component of FIG. 7;

FIG. 10 is a cross-section along the line 10-10 of FIG. 9 of the component of FIG. 7.

### DETAILED DESCRIPTION OF THE INVENTION

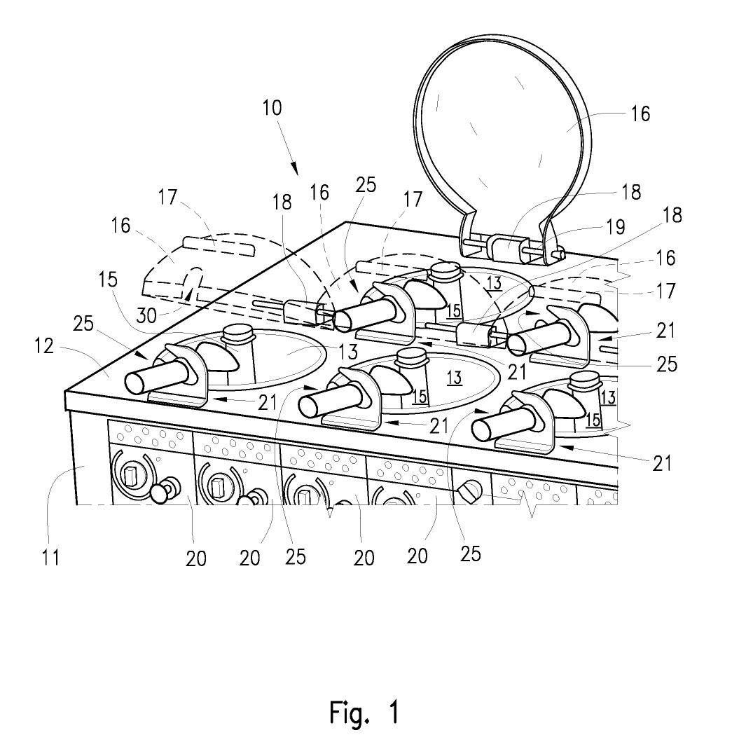

The display batch freezer of FIG. 1, being generically shown as 10, includes a bench 11 having a shelf 12.

In the shelf 12, a number of batch freezing receptacles 13 is methodically fitted.

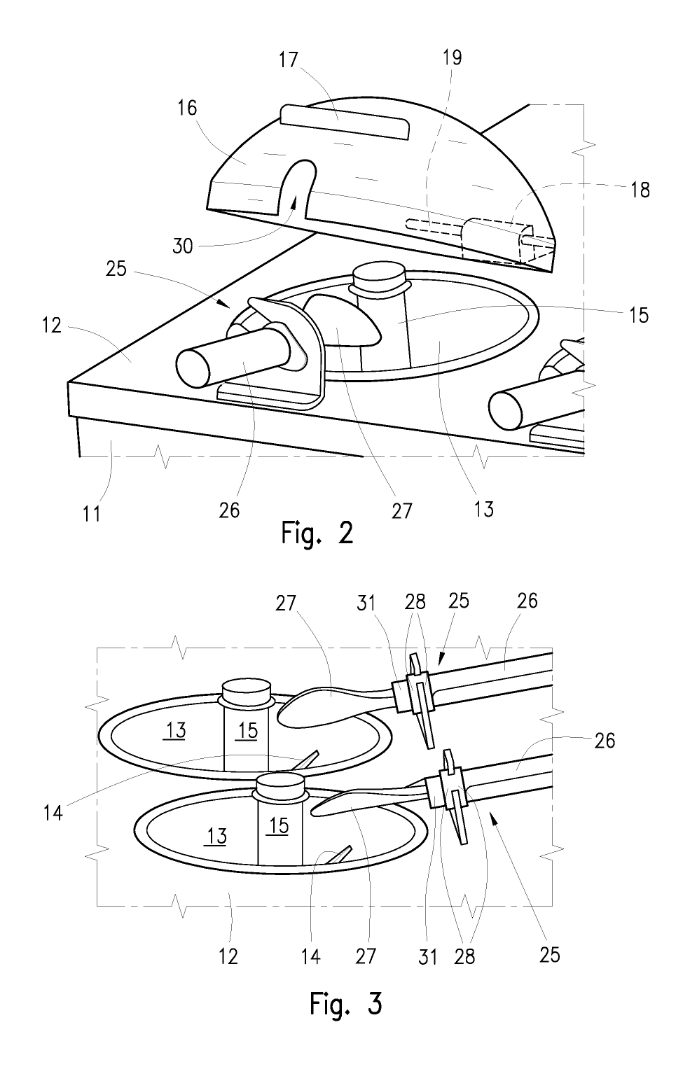

In each batch freezing receptacle 13, a stirrer 14 is operating, which is partially visible in FIG. 3, fitted on a shaft 15, being rotationally driven by a respective electric motor being arranged inside the bench 11. The stirrer 14 is provided with a blade having a scraping skid and with a squeegeeing blade.

Each batch freezing receptacle 13 is closed by a transparent doom-shaped lid 16. Each lid 16 is provided with a grip 17 and is hinged to a hinge 18 through a rod 19, in order to being able to rotate between a closed position and an open position of the respective batch freezing receptacle 13.

Inside the bench 11, in addition to the motors driving the stirrers 14, there are arranged a refrigeration circuit and several electrical and electronic components.

Opposite to the hinge 18 of each lid 16 a magnetic micro switch, not shown, is provided which provides for disabling the electrical motor of the stirrer 14 in the batch freezing receptacle 13 being associated to the lid 16, when the lid 16 is opened, in order to prevent the stirrer access when it is moving and avoid damages. The magnetic micro switch can be made by at least one magnet arranged on the edge of the lid 16 and at least one sensor arranged under the shelf 12 in correspondence to the magnet.

On the front wall of the bench 11 a number of control panels 20 is provided, each one being dedicated to a respective batch freezing receptacle 13 and stirrer 14. The controls of each control panel 20 allow regulating the temperature inside the respective batch freezing receptacle 13 and activating or stopping the stirrer 14.

In each batch freezing receptacle 13, a fluid mixture is introduced in order to make the ice-cream, therefore the refrigeration circuit and the stirrer 14 are activated so to obtain the ice-cream by the combined action of compound stirring, cooling thereof and air inclusion therein.

In order to collect the ice-cream made in the batch freezing receptacles 13, the display batch freezer 10 provides the following.

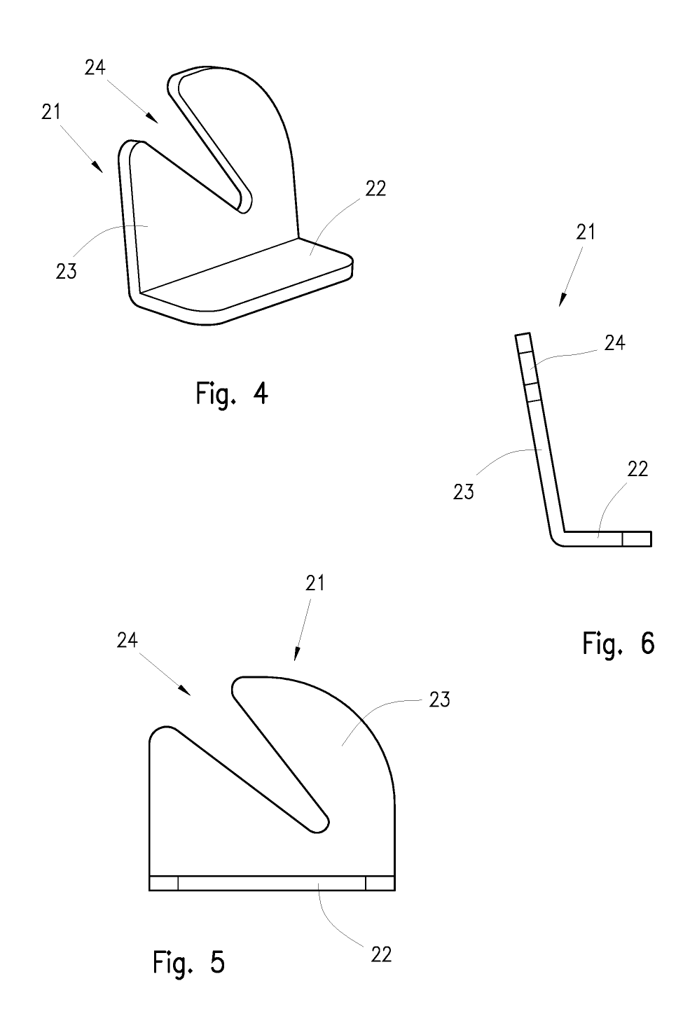

Near each batch freezing receptacle 13, a support 21 is provided, which is well visible in FIGS. 1-3 and shown in detail in FIGS. 4-6. Each support 21 has a substantially L-shaped profile and comprises a base 22 and a wall 23 extending upwards from one side of the base 22 in a slightly tilted way with respect to the vertical axis. The base 22 is fastened to the supporting plane 12 of the bench 11. The wall 23 has a substantially V-shaped notch 24 being tilted with respect to the vertical axis.

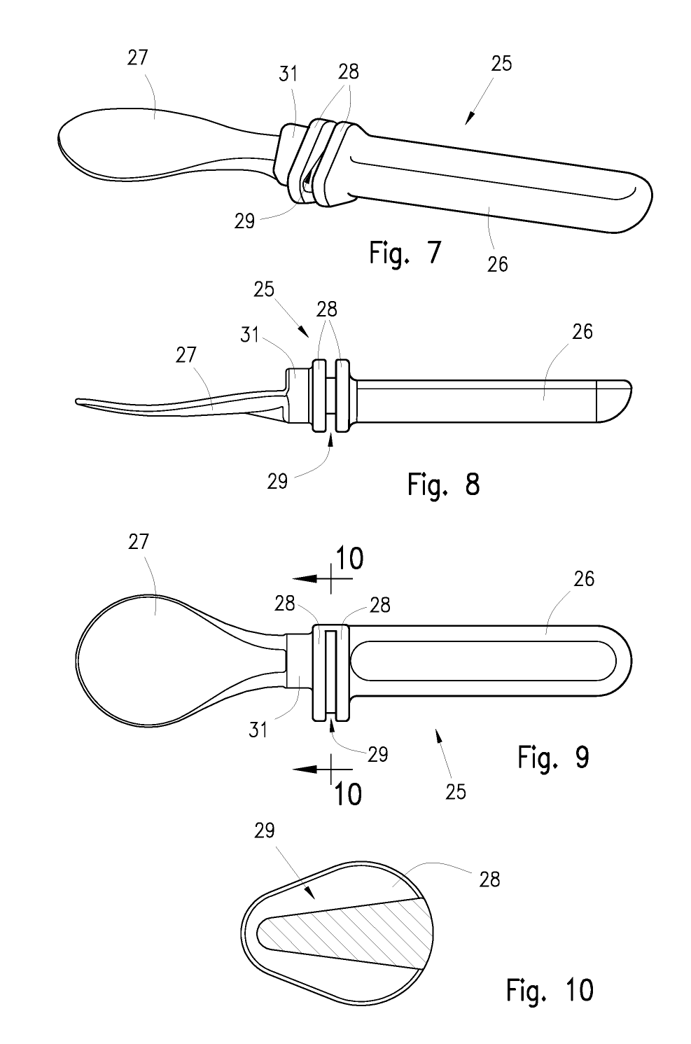

Each support 21 is intended to house a respective scoop 25, which is well visible in FIGS. 1-3 and shown in detail in FIGS. 7-10. The scoop 25 comprises an extended gripping part 26 and a concave collecting part 27. The gripping part 26, near the collecting part 27, has two identical and parallel drop profiled reliefs 28, among which an annular groove 29 is formed.

As it is possible to see in FIGS. 1-3, each scoop 25 is supported by a respective support 21 by inserting the gripping part 26 in the support 21 so that the groove 29 is mechanically coupled to the notch 24 of the wall 23 of the support 21.

The gripping part 26 of the scoop 25 extends outwards from the respective batch freezing receptacle 13, while the collecting part 27 extends inwards the batch freezing receptacle 13 staying over the receptacle edge. Given the tilt of the wall 23 of the support 21, the scoop 25 is slightly forward tilted towards the batch freezing receptacle 13.

In each lid 16, an arc-shaped notch 30 is made in which a connection part 31 of the scoop 25 is inserted between the gripping part 26 and the collecting part 27 when the lid 16 is closed. In this way, the gripping part 26 is outside the lid 16 and the collecting part 27 is inside the lid 16.

When the stirrer 14 is operating in the batch freezing receptacle 13 in order to make ice-cream, the collecting part 27 of the scoop 25 does not interfere with either the stirrer 14 or the product being made, since it is placed over the edge of the batch freezing receptacle 13.

Once made the ice-cream, stopped the stirrer 14, and opened the lid 16, it will be possible to collect the ice-cream using the scoop 25 by simply extracting it from its support 21.

The described and shown display batch freezer 10 has several advantages.

When the scoop 25 is on the support 21 and the lid 16 is closed, its collecting part 27 is housed in a protected ambient, inside the lid 16, so to prevent bacteria or other pathogens from depositing thereon, allowing an ice-cream collection that fully satisfies the hygiene requirements.

Moreover, the gripping part 26, which is contacting the operator's hand, stays outside and prevents any ice-cream contamination.

It should be added that the ambient where the collecting part 27 of the scoop 25 is housed is cold since it stands above the batch freezing receptacle 13 inside the lid 16. In this way, the collecting part 27 of the scoop 25 stays cold so that, when the ice-cream is collected using the scoop 25 from the batch freezing receptacle 13 and is arranged on the cone or in the paper cup, it keeps its initial texture, being attractive for the client.

If the scoop 25 is placed in a wrong way on the support 21, the lid 16 does not close correctly and the micro switch does not enable the motor activation of the stirrer 14 so to avoid possible damages.

Using the display batch freezer 10, similarly, it will be possible to make sorbets, slushes and the like.

What seen above can be applied to any machine for making ice-creams, sorbets, slashes and the like, which also has the display function.

It is clear that variations and/or additions can be envisaged to what described and shown above.

The configuration of the scoop and its support can vary, as well as the opening shape in the lid can vary.

The support will need to guarantee keeping the scoop firmly in a position where the gripping part is outside the lid and the collecting part is inside the lid; the opening in the lid will need to guarantee that the scoop passes through the lid.

The coupling between the support and the scoop could be an interlocking one as in the example, or an elastic coupling one, or a magnetic one, or the like.

1. A display batch freezer for ice-creams, sorbets, slushes and similar products, comprising a bench with a shelf in which at least one batch freezing receptacle is fitted that is closed by a lid and in which a stirrer is operating, characterised in that at the batch freezing receptacle a support is fixed on which a tool is fitted removably for collecting the product, wherein the tool comprises a gripping part and a collecting part, wherein the tool is arranged with the gripping part outside the lid and with the collecting part inside the lid, and wherein the lid has an opening for the tool to pass through the lid.

2. The display batch freezer according to claim 1, wherein a plurality of batch freezing receptacles is provided at each of which there is a respective support and a respective tool for collecting the product.

3. The display batch freezer according to claim 1, wherein the collecting part of the tool is arranged above the edge of the batch freezing receptacle.

4. The display batch freezer according to claim 1, wherein the tool is coupled mechanically with the support.

5. The display batch freezer according to claim 4, wherein the support has a notch into which a grooved part of the tool is inserted.

6. The display batch freezer according to claim 5, wherein the notch has a V shape and the grooved part has a drop profile.

7. The display batch freezer according to claim 1, wherein the opening of the lid is formed by an arc-shaped notch.

8. The display batch freezer according to claim 1, comprising means for disabling the drive of the stirrer when the lid is open.

9. The display batch freezer according to claim 1, wherein the tool has the shape of a scoop.

10. The display batch freezer according to claim 1, wherein the tool is coupled magnetically with the support.

11. The display batch freezer according to claim 2, wherein the collecting part of the tool is arranged above the edge of the batch freezing receptacle.

12. The display batch freezer according to claim 2, wherein the tool is coupled mechanically with the support.

13. The display batch freezer according to claim 3, wherein the tool is coupled mechanically with the support.
